(19) United States
(12) Patent Application Publication
(10) Pub. No.: US 2007/0062189 A1
(43) Pub. Date: Mar. 22, 2007

(54) Method and apparatus for operating an internal combustion engine having exhaust gas turbocharging

(76) Inventors: Berthold Keppeler, Owen (DE); Arno Nolte, Stuttgart (DE)

Correspondence Address: KLAUS J. BACH, 4407 TWIN OAKS DRIVE, MURRYSVILLE, PA, 15668, US

(21) Appl. No.: 11/522,491

(22) Filed: Sep. 15, 2006

Related U.S. Application Data
(63) Continuation-in-part of application No. PCT/EP05/02610, filed on Mar. 11, 2005.

(30) Foreign Application Priority Data
Mar. 18, 2004 (DE) 10 2004 013 232.1

(51) Int. Cl. F01N 3/00; F02B 33/44

(52) U.S. Cl. 60/605.1; 60/289; 60/607; 60/608; 60/602

(57) ABSTRACT

in a method for operating a supercharged internal combustion engine and an internal combustion engine including an exhaust gas treatment system which comprises a catalytic converter arranged close to the engine, an exhaust gas turbocharger which is arranged downstream of the catalytic converter, and a post-injection device for introducing additional fuel into the exhaust gas flow upstream of the catalytic converter, wherein the heat energy of the exhaust gas mass flow which acts on the exhaust gas turbocharger is varied by controlling the fuel quantity which is additionally introduced into the exhaust gas flow by means of the post-injection device resulting in an improvement in the response behavior of the internal combustion engine, excess energy which is generated by the exhaust gas turbocharger by means of a motor generator connected to the exhaust gas turbocharger is stored in a storage device and is returned to the motor generator for rapidly accelerating the turbocharger when an increased power output is demanded from the engine.

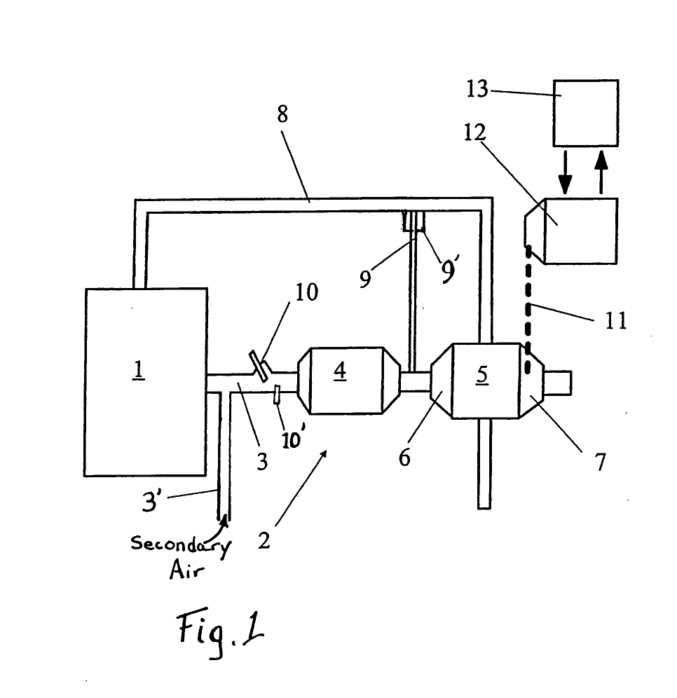

This is a Continuation-in-Part Application of International Application PCT/EP2005/002610 filed Mar. 11, 2005 and claiming the priority of German Application 10 2004 013.1 filed Mar. 18, 2004.

### BACKGROUND OF THE INVENTION

The invention relates to a method and apparatus for operating an internal combustion engine including an exhaust gas turbocharger, with an exhaust gas turbine which is acted on, at least in the event of a positive load change of the internal combustion engine, with an increased exhaust gas mass flow as a result of an additional fuel supply and/or air supply, and with additionally increased exhaust gas energy as a result of conversion of the exhaust gas mass flow in a catalytic converter, so that the speed of the exhaust gas turbocharger is increased resulting in a rapid increase of the charge pressure of the internal combustion engine.

Such a method for operating an internal combustion engine having an exhaust gas turbocharger in the exhaust system is known from DE 41 39 291 A1. A catalytic converter, which can be an oxidation catalytic converter, is arranged upstream of the exhaust gas turbocharger.

During a cold start or in the event of a positive load change of the internal combustion engine, the exhaust gas mass flow is increased as a result of an additional injection of fuel into the exhaust gas, and the exhaust gas energy in the exhaust gas mass flow is increased considerably overall as a result of post-combustion of the unburned fuel constituents in the catalytic converter. The exhaust gas turbocharger is then acted on with the increased exhaust gas energy, resulting in a faster increases of the exhaust gas turbocharger speed and therefore to a higher charge pressure. This results in a fast response of the internal combustion engine with high torque build-up even at low speeds.

A disadvantage is that, in the known method, it is not possible to operate the internal combustion engine with exhaust gas recirculation for an improved control of the operating behavior of the internal combustion engine. It is also a disadvantage that an improvement of the system efficiency is not provided in the event of a negative load change. In addition, the system requires secondary air in order to be able to function in the substoichiometric range (λ<1). Furthermore, the described arrangement is limited to a metering of fuel within the engine.

It is the object of the present invention to provide a method and apparatus for operating an internal combustion engine with an improved system efficiency and improved dynamics resulting in reduced exhaust gas pollutant values.

### SUMMARY OF THE INVENTION

In a method for operating a supercharged internal combustion engine and an internal combustion engine including an exhaust gas treatment system which comprises a catalytic converter arranged close to the engine, an exhaust gas turbocharger which is arranged downstream of the catalytic converter, and a post-injection device for introducing additional fuel into the exhaust gas flow upstream of the catalytic converter, wherein the heat energy of the exhaust gas mass flow which acts on the exhaust gas turbocharger is varied by controlling the fuel quantity which is additionally introduced into the exhaust gas flow by means of the post-injection device resulting in an improvement in the response behavior of the internal combustion engine, additionally excess energy which is generated by the exhaust gas turbocharger is by means of a motor generator connected to the exhaust gas turbocharger and is stored in a storage device and is returned to the motor generator for rapidly accelerating the turbocharger when an increased power output is demanded from the engine.

By virtue of the fact that excess charging energy derived from the exhaust gas turbocharger is transferred to a motor-generator unit, the excess energy can be stored as electrical energy in a battery. The excess charging energy is therefore available to the system overall as additional energy, ultimately resulting in the system efficiency being increased.

It is finally also advantageous that the motor-generator unit can be operated, in order to generate energy, by means of the coupled exhaust gas turbocharger as a result of the secondary fuel injection and a secondary introduction of air, without the internal combustion engine being operated.

The invention will become more readily apparent from the following description of an exemplary embodiment of the invention on the basis of the accompanying drawing.

### BRIEF DESCRIPTION OF THE DRAWING

The sole FIGURE shows schematically an engine operating system according to the invention.

### DESCRIPTION OF A PREFERRED EMBODIMENT

A reciprocating piston internal combustion engine, which can be a diesel or spark ignition engine, is denoted by the numeral 1.

An exhaust system which is denoted overall by the reference numeral 2 is connected to the outlet side of the engine 1. The exhaust system comprises an exhaust gas line 3 having a catalytic converter 4 which is installed close to the engine 1 and has an exhaust gas turbocharger 5 which is arranged downstream of the catalytic converter 4 in the exhaust gas line 3 which leads to an exhaust gas turbine 6 of the exhaust gas turbocharger 5. The exhaust gas turbine 6 drives the compressor 7 for feeding combustion air, via a combustion air intake line 8, to the intake side of the engine.

The exhaust gas system 2 also comprises an exhaust gas recirculation line 9, which branches off from the exhaust gas line part of the exhaust gas line 3 which is situated between the catalytic converter 4 and the exhaust gas turbocharger 5, and extends to that part of the combustion air intake line 8 which is situated downstream of the compressor 7. Here, an exhaust gas recirculation valve 9′ may optionally be arranged in the exhaust gas recirculation line 9. The arrangement of the exhaust gas recirculation line 9 downstream of the catalytic converter 4 has the advantage that the danger of the exhaust gas recirculation line 9 becoming soot-coated by unconverted exhaust gas constituents, for example hydrocarbons, is minimized, since said exhaust gas constituents are removed from the exhaust gas when it passes through the catalytic converter 4.

The internal combustion engine 1 is suitable both for an operating mode with a substoichiometric air/fuel ratio (rich mixture) and with a superstoichiometric air/fuel ratio (lean mixture). Accordingly, the catalytic converter 4 is an oxidation catalytic converter and/or as a NO_{X} storage catalytic converter. A catalytic converter which completely or partially converts excess hydrocarbons into a mixture containing H₂/CO (by means of partial oxidation, steam reforming, autothermic reforming or any desired combinations thereof) in the substoichiometric operating mode (λ<1) can also optionally be used. This reduces the HC emissions in substoichiometric operation and, if appropriate, facilitates the regeneration of an optional NO_{X} storage catalytic converter (deNO_{X}+deSO_{X}) which can be positioned downstream. In order to introduce additional fuel into the exhaust system (for enrichment and/or for the generation of exothermic phenomena) in a targeted fashion and independently of the combustion within the engine, a secondary post-injection device 10 is arranged in the exhaust gas line 3 upstream of the catalytic converter 4 for injecting fuel into the exhaust gas line. The secondary fuel injection can either be activated in addition to, or else separately from, the late post injection within the engine.

According to the invention, the system efficiency of the internal combustion engine, and simultaneously the exhaust gas emissions during a cold start, are to be improved by means of the post-injection device 10 and/or a late post injection (NE) within the engine.

For this purpose, an additional quantity of fuel is injected into the exhaust gas line 3 during a cold start of the internal combustion engine 1 by means of the post-injection device 10 or by means of a late post-injection within the engine. The additional quantity of fuel is converted, together with the unburned exhaust gas constituents of the internal combustion engine 1, in the catalytic converter 4 which is close to the engine. As a result of being arranged close to the engine, and of the additional fuel quantity, the catalytic converter 4 reaches its operating temperature within a very short time, so that the catalytic converter 4 is capable of converting the exhaust gas constituents of the internal combustion engine 1 and the unburned fuel already right after the internal combustion engine is started. Furthermore, the catalytic converter may include electric heating means. As a result of these measures, an increased exhaust gas mass flow with a relatively high temperature and therefore with high exhaust gas energy overall is already generated during a cold start, said increased mass flow acting on the exhaust gas turbocharger 5, resulting in the latter being accelerated from a low speed range to a high speed range with a relatively high charge pressure in an accelerated fashion. This results already in the cold start phase in a fast response of the internal combustion engine 1 with a high torque build-up at low speeds. The catalytic converter which is arranged upstream of the exhaust gas turbocharger 5 can optionally be electrically heated (improved cold start behavior).

In the same way, for an internal combustion engine. 1 which is at operating temperature, in the event of a positive load change being demanded of the internal combustion engine 1, the response of the internal combustion engine 1 can be improved with regard to a fast torque build-up by introducing an additional fuel quantity into the exhaust gas flow by means of the post-injection device 10 and/or a late post-injection within the engine. Also in this case, as it is during a cold start, the exhaust gas mass flow is increased considerably as a result of the introduction of an additional fuel quantity into the exhaust gas flow upstream of the catalytic converter 4, and the exhaust gas energy of the exhaust gas flow is increased considerably as a result of the subsequent conversion in the catalytic converter 4, so that the exhaust gas turbocharger 5 to which the increased exhaust gas energy is supplied is rapidly accelerated, resulting in the quickly increasing charge pressure, resulting in the fast response of the internal combustion engine 1.

In the event of a negative load change at the internal combustion engine, charging energy which cannot be directly utilized for operating the internal combustion engine 1 is generated at the exhaust gas turbocharger 5. So that said charging energy is not lost, according to the invention, the exhaust gas turbocharger 5 is connected by means of a mechanical drive connection 11 to an electrical motor-generator unit 12 which generates electrical energy from the excess charging energy of the exhaust gas turbocharger 5, the electrical energy then being stored in a battery 13.

Within the context of the invention, it is optionally provided not only that the energy which is released in the event of a negative load change is stored, but rather fundamentally each quantity of excess energy which is generated at the exhaust gas turbocharger 5 is to be stored in the battery 13 by way of the motor-generator unit 12. The operation of the exhaust gas turbocharger 5 can be influenced, by means of the fuel quantity which is introduced, in such a way that excess charging energy at the exhaust gas turbocharger 5 can be generated and stored even in the cold start phase, in the event of a positive load change of the internal combustion engine or else during constant load operation.

The excess charging energy which is stored in this way can be utilized both to rapidly accelerate the exhaust gas turbocharger 5 and to supply power to other electrical devices of the internal combustion engine 1 or of the vehicle which is driven by the internal combustion engine 1, resulting in the system efficiency being improved overall.

An extremely fast acceleration of the exhaust gas turbocharger 5 should likewise be permitted in the event of an extreme positive load change of the internal combustion engine 1 from a low load range into an upper load range. In order to facilitate this, the exhaust gas turbocharger is not only acted on with an increased quantity of exhaust gas energy from the exhaust gas flow, but rather is additionally mechanically driven by the motor-generator unit.

It is noted that the post-fuel injection may be initiated, and the motor/generator unit (12) energized for driving the exhaust gas turbocharger (5) regardless of an actuating speed of an accelerator pedal and therefore regardless of the combustion within the engine.

Also, the means for introducing post-injection fuel is preferably a normal fuel valve (10) with a flame glow plug (10′) whereby the fuel introduced can simultaneously be metered, heated and vaporized.

What is claimed is:

1. A method of operating an internal combustion engine (1) including an exhaust gas turbocharger (5) with an exhaust gas turbine (6) to which, at least in the event of a positive load change of the internal combustion engine (1), an increased exhaust gas mass flow is supplied as a result of an additional fuel supply and air input providing an increased exhaust gas energy as a result of conversion of the exhaust gas mass flow in a catalytic converter (4), whereby the exhaust gas turbocharger (5) is rapidly accelerated to a higher turbocharger speed and a higher charge pressure, said method comprising the steps of:
supplying excess energy available from at the exhaust gas turbocharger (5) to a motor-generator unit (12) for generating electrical energy which is stored in a storage unit 13, and, in the event of a load change of the internal combustion engine from a low load level to a high load level, driving the exhaust gas turbocharger (5) additionally by the motor-generator unit (12) such that the exhaust gas turbocharger (5) is rapidly accelerated to a higher turbocharger speed so as to rapidly increase the charge pressure generated thereby.

2. The method of operating an internal combustion engine as claimed in claim 1, wherein the post-fuel injection is initiated, and the motor/generator unit (12) is energized for driving the exhaust gas turbocharger (5) regardless of an actuating speed of an accelerator pedal and therefore regardless of the combustion within the engine.

3. An internal combustion engine (1) including an exhaust gas turbocharger (5) with an exhaust gas turbine (6) connected to the internal combustion engine (1) by an exhaust line (3) via a catalytic converter (4) for supplying engine exhaust gas to the exhaust gas turbine (6) via the catalytic converter (4), means (10) for introducing post-injection fuel into at least one of the engine (1) and the exhaust line (3) upstream of the catalytic converter (4) for combustion therein, thereby heating the catalytic converter (4) and generating an increased volume exhaust gas flow to the turbine (6) providing for excess power output of the turbine (6), a motor generator unit (12) connected to the turbocharger (5) to be driven thereby when excess energy is available from the turbocharger (5), an electric power storage device (13) connected to the motor generator (12) for receiving therefrom the excess energy and storing it in the power storage device (13) and returning it to the motor generator (12) for rapidly accelerating the turbocharger (5) when an increased power output is demanded from the engine (1).

4. The internal combustion engine as claimed in claim 3, wherein the means for introducing post-injection fuel is a normal fuel valve (10) with a flame glow plug (10′) whereby the fuel introduced can simultaneously be metered, heated and vaporized.

5. The internal combustion engine according to claim 3, wherein the catalytic converter (4) is an oxidation catalytic converter.

6. The internal combustion engine according to claim 3, wherein the catalytic converter (4) is an NO_{X} storage catalytic converter.

7. The internal combustion engine according to claim 3, wherein the catalytic converter (4) is a combined storage catalytic converter and oxidation catalytic converter.

8. The internal combustion engine according to claim 3, wherein the catalytic converter includes heating means.

9. The internal combustion engine according to claim 3, wherein a catalytic converter (4) is provided which is capable of converting in the substoichiometric range (λ<1), at least partially, excess hydrocarbons into a mixture containing H₂ and CO.

10. The internal combustion engine according to claim 3, including an exhaust gas recirculation line (9), which branches off the exhaust system (2) between the catalytic converter (4) and the exhaust gas turbocharger (5).

11. An internal combustion engine as claimed in claim 3, including means (3′) for introducing, during acceleration phases, secondary air into the exhaust system (2) upstream of the catalytic converter (4) to set λ<1 at the full-load limit.
